(19) United States
(12) Patent Application Publication
(10) Pub. No.: US 2016/0272356 A1
(43) Pub. Date: Sep. 22, 2016

(54) LIGHTWEIGHT DAIRY CONTAINER

(71) Applicant: Mid-America Machining, Inc., Brooklyn, MI (US)

(72) Inventors: Matt Simpson, Tecumseh, MI (US); Kevin D. Gaydosh, Adrian, MI (US); Peter Lobbestael, Manitou Beach, MI (US)

(21) Appl. No.: 15/070,402

(22) Filed: Mar. 15, 2016

Related U.S. Application Data
(60) Provisional application No. 62/133,519, filed on Mar. 16, 2015.

(51) Int. Cl. B65D 1/02; B65D 85/80; B29C 49/48; B65D 23/10

(52) U.S. Cl. CPC B65D 1/0223; B65D 23/10; B65D 85/80; B29C 49/48; B65D 2501/0081; B29L 2031/757

(57) ABSTRACT

A blow-molded dairy container includes a spout that is arranged on a spout axis; a bottom portion; a handle; an upwardly converging top portion; short sidewalls that includes a first longitudinal sidewall that is located adjacent to the handle, a second longitudinal sidewall that is located opposite the first longitudinal sidewall, a first transverse sidewall, and a second transverse sidewall that is located opposite the first transverse sidewall and is offset from the first transverse sidewall in a longitudinal direction; and long sidewalls that are each positioned between a respective pair of the short sidewalls. A first pair of the long sidewalls are spaced by a first width dimension, a second pair of the long sidewalls are spaced by a second width dimension, the first width dimension is a maximum of six inches, and the second width dimension is between 90.0 and 96.14 percent of the first width dimension.

### CROSS-REFERENCE TO RELATED APPLICATIONS

This application claims the benefit of U.S. Provisional Application No. 62/133,519, filed on Mar. 16, 2015.

### BACKGROUND

In the field of containers for storing liquids such as dairy products, blow-molded containers are commonly used, are manufactured in a variety of sizes, and are manufactured using a variety of thermoplastic materials.

Blow-molded containers can be manufactured using a conventional blow-molding machine that includes a loading station where pelletized thermoplastic material, such as polyethylene, is introduced into a hopper or feed bin. The hopper, in turn, feeds the pelletized or granular thermoplastic materials at room temperature to a heater/drive system. The heater/drive system typically includes a screw drive and one or more heating mechanisms or elements that gradually raise the temperature of the thermoplastic material to approximately 365 degrees Fahrenheit. At this temperature, the material liquefies and becomes taffy-like in consistency. The material is then introduced into the mold through a die and mandrel combination that distributes the thermoplastic material in the mold. The blob of thermoplastic material which forms as it is extruded through the gauged opening between the die and mandrel is called a parison. Once the parison is formed the mold is closed around the parison possibly imparting the general shape of the interior of the mold onto the parison. This aids in distributing the material of the parison evenly throughout the interior of the mold when the mold is pressurized. The mold is then pressurized via the blow pin thereby forcing the parison to expand throughout the interior of the walls of the mold, and imparting to the material the finished shape of a container. To facilitate the molding process, the mold walls are cooled to approximately 30 to 40 degrees Fahrenheit, to restore the liquefied thermoplastic material to solid state. Once the part has formed, the mold is opened and the part is removed from the mold.

Dairy containers of this type typically have a finished weight of over sixty grams for a one gallon size container. The amount of material utilized is primarily a function of wall thickness, in that the wall thickness is a primary factor in the strength of the container. These containers must have sufficient strength to withstand the industrial filling process, in particular, the loads imposed for securement of a closure, such as a cap, lid or screw top to the spout on the top of the container. The blow molding process used for many prior art containers of this type leads to uneven wall thicknesses at certain areas of the container, causing the walls to be thicker than necessary in some areas, thereby needlessly increasing the overall weight of the container.

Existing methods of transporting and merchandising dairy products place constraints on the designs that can be utilized for dairy containers. Thus, efforts to create strong and light containers focus on doing so while maintaining the ability to fit the new container design within the space available in standard dairy crates and dairy coolers. Need remains for lightweight bottle designs that can be transported in standard dairy crates and efficiently stored in existing dairy coolers.

### SUMMARY

One aspect of the disclosed embodiments is a blow-molded dairy container that includes a spout that is arranged on a spout axis; a bottom portion; a handle; an upwardly converging top portion; short sidewalls that include a first longitudinal sidewall that is located adjacent to the handle, a second longitudinal sidewall that is located opposite the first longitudinal sidewall, a first transverse sidewall, and a second transverse sidewall that is located opposite the first transverse sidewall and is offset from the first transverse sidewall in a longitudinal direction; and long sidewalls that are each positioned between a respective pair of the short sidewalls. A first pair of the long sidewalls are spaced by a first width dimension, a second pair of the long sidewalls are spaced by a second width dimension, the first width dimension is a maximum of six inches, and the second width dimension is between 90.0 and 96.14 percent of the first width dimension.

Another aspect of the disclosed embodiments is a mold for making a blow-molded dairy container. The mold includes two or more mold portions that define a mold cavity having: a spout section for forming a spout that is arranged on a spout axis, a bottom section for forming a bottom portion, a handle section for forming a handle, a top section for forming an upwardly converging top portion, and a sidewall section for forming a short sidewalls and long sidewalls, the short sidewalls including a first longitudinal sidewall that is located adjacent to the handle, a second longitudinal sidewall that is located opposite the first longitudinal sidewall, a first transverse sidewall, and a second transverse sidewall that is located opposite the first transverse sidewall and is offset from the first transverse sidewall in a longitudinal direction, and the long sidewalls each being positioned between a respective pair of the short sidewalls. wherein a first pair of the long sidewalls are spaced by a first width dimension, the first width dimension is a maximum of six inches, a second pair of the long sidewalls are spaced by a second width dimension, and the second width dimension is between 90.0 and 96.14 percent of the first width dimension.

### BRIEF DESCRIPTION OF THE DRAWINGS

The description herein makes reference to the accompanying drawings, wherein like referenced numerals refer to like parts throughout several views, and wherein:

FIG. 1 is a perspective view showing a container;

FIG. 2 is a left side view of the container;

FIG. 3 is a rear view of the container;

FIG. 4 is a top view of the container;

FIG. 5 is a bottom view of the container;

FIG. 6 is a perspective view showing a mold.

FIG. 7 is a top view of a container according to a first alternative example.

FIG. 8 is a top view of a container according to a second alternative example.

FIG. 9 is a top view of a dairy crate.

FIG. 10 is a front view of a retail display cooler.

### DETAILED DESCRIPTION

The disclosure herein is directed to lightweight dairy containers. The containers described herein can be transported in standard dairy crates and efficiently stored in existing dairy coolers by employing a non-symmetrical footprint that does not sacrifice strength or increase weight. The containers described herein can be produced at weights that are significantly less than sixty grams.

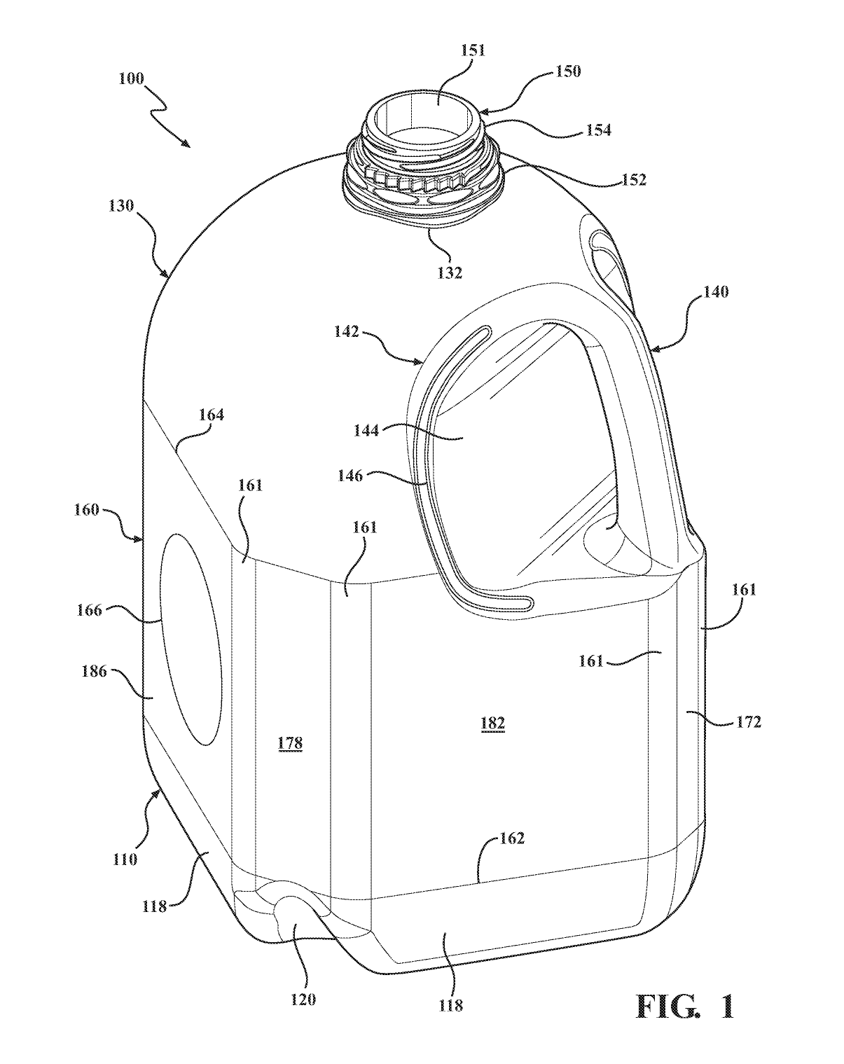

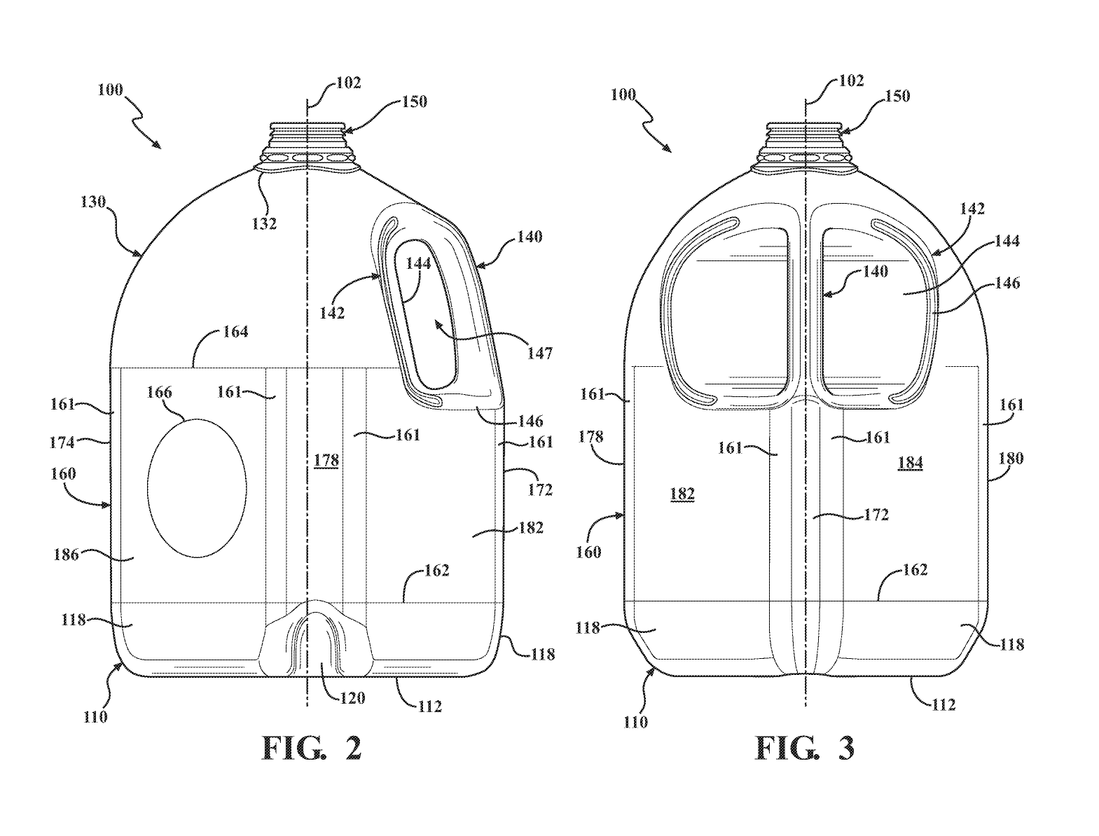

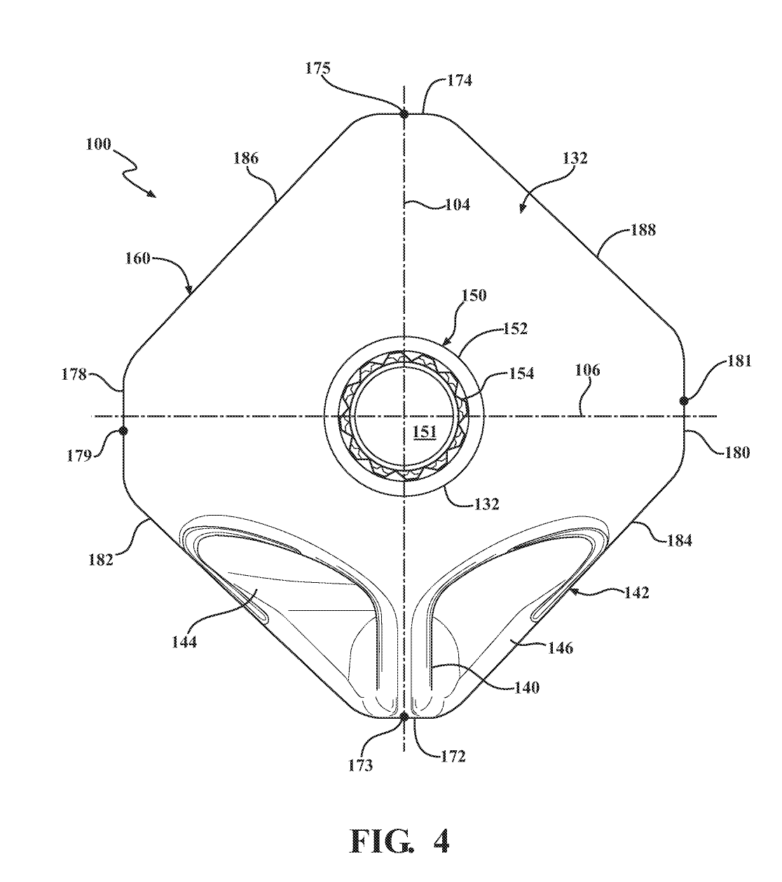

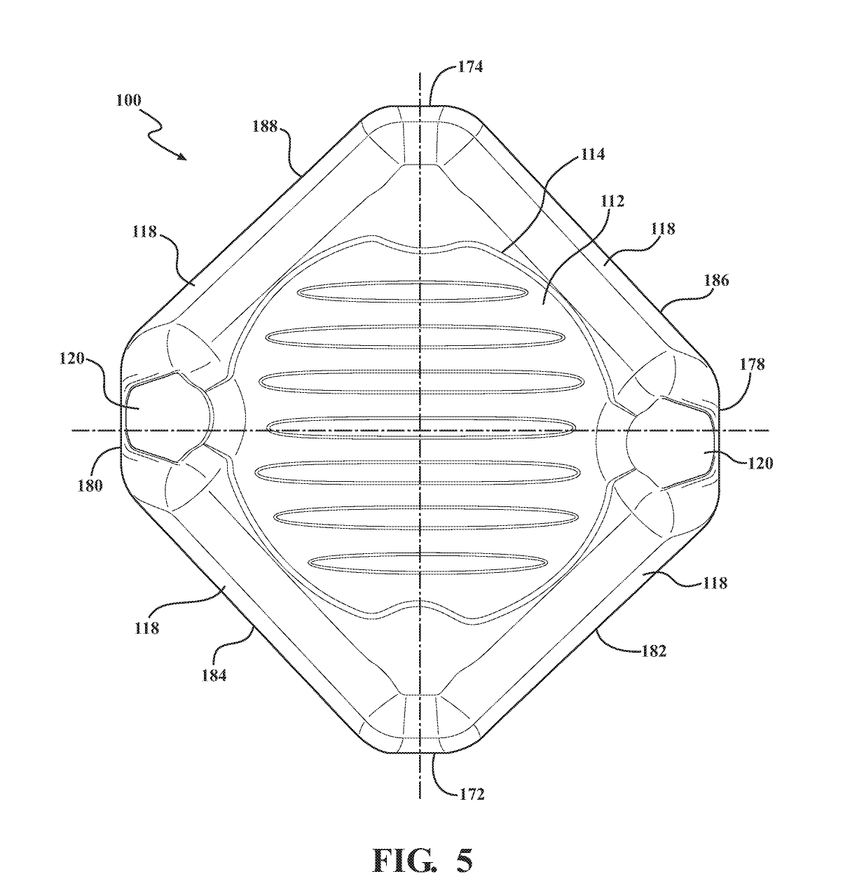

FIGS. 1-6 show a container 100. The container 100 is a blow-molded container that is formed from a thermoplastic material. The container 100 is thin-walled and is formed as a single piece structure. As a result of the thin walled construction of the container 100, a hollow interior is defined. The hollow interior of the container 100 can be utilized to store materials such as liquids and granular materials, with the container 100 be particular suitable to storing liquids such as dairy products. In the illustrated example, the container 100 is a one gallon size container that is intended to hold dairy products, such as milk, and is approximately ten inches tall.

The container 100 is arranged around a spout axis 102 and includes a bottom portion 110, a top portion 130, a handle 140 that is defined within a handle area 142, a spout 150, and a sidewall portion 160. When viewed from above, the largest part of the container 100 is defined within the sidewall portion 160, and defines a shape for the container 100 that is referred to herein as the footprint of the container.

The bottom portion 110 of the container 100 includes a base panel 112 that is generally planar and extends substantially perpendicular to the spout axis 102 of the container 100. The base panel 112 is a generally planar surface that is configured to contact a subjacent surface (e.g. a shelf or countertop) to allow the container 100 to be set down and remain in a generally upright position. The base panel 100 has a periphery 114 that is smaller than the footprint of the container 100. The base panel 112 can include ribs 116 and/or other features that serve to strengthen the base panel 112 such that it resists deformation when the container 100 is filled with liquid.

The bottom portion 110 of the container 100 also includes bottom transition panels 118 that define a generally convex shape when viewed from the outside of the container 100. The bottom transition panels 118 widen the container 100 from the periphery 114 of the base panel 112 to the sidewall portion 160. The point at which the bottom transition panels 118 meet the sidewall portion 160 is referred to herein as a lower limit 162 of the sidewall portion 160. The lower limit 162 of the sidewall portion 160 can lie at a consistent height relative to the overall height of the container 100 (e.g. in a plane perpendicular to the spout axis 102) or can vary in height relative to the overall height of the container 100. At one or more of the corners of the container 100, concave transition sections 120 can be formed to further strengthen the bottom portion 110 of the container 100. In some implementations, the concave transition sections 120 extend from the periphery 114 of the base panel 112 to the lower limit 162 of the sidewall portion 160.

The top portion 130 converges upwardly to provide a smooth transition from the sidewall portion 160 to the spout 150. The top portion 130 can include a constant curvature that narrows the container 100 progressively and continuously to define a convex profile for the top portion 130, except within the handle area 142. The constant curvature of the top portion 130 extends from an upper limit 164 of the sidewall portion 160 to an intersection 132 where the top portion 130 meets a base part 152 of the spout 150.

The handle 140 is a hollow member that is defined with the handle area 142 of the container 100. The handle area 142 abuts the sidewall portion 160 and the top portion 130 of the container 100. Within the handle area 142, the geometry of the container 100 deviates from the nominal geometry of the top portion 130 of the container 100 by virtue of a generally flat wall 144 and transition surfaces 146 that extend from the generally flat wall 144 to the top portion 130, the handle 140, and the sidewall portion 160. The generally flat wall 144 is defined in order to provide an open space between the handle 140 and the remainder of the container 100 in the form of a handle opening 147, with the handle 140 meeting the sidewall portion 160 at a lower end of the handle 140 and with the handle 140 meeting the top portion 130 at an upper end of the handle 140. The handle opening 147 allows the handle 140 to be grasped, such as by a user's hand extending partially into the handle opening 147. An exterior surface 148 of the handle 140 extends from the sidewall portion 160 to the top portion 130.

In order to allow the container 100 to be filled and emptied, such as by pouring, the container 100 includes the spout 150 which defines an opening 151 through which materials can pass. The spout 150 extends upward from the top portion 130 of the container 100, and can be arranged around the spout axis 102 with the spout axis 102 extending along a radial center of the spout 150. The spout 150 can include the base part 152 and a connector part 154. The base part 152 can be an upright cylindrical member that extends along the spout axis 102, such that the spout axis 102 is located along a radial center of the base part 152. The connector part 154 is adapted to engage and connect to a cap (not shown) for closing the container 100 such that liquids disposed within the container 100 are retained and isolated from external contaminants. The particular geometry of the connector part 154 varies, and can be formed according to any of a number of well-known standard cap connector designs as well as future cap connector designs.

The sidewall portion 160 is defined by substantially continuous geometry from the lower limit 162 to the upper limit 164 or the handle area 142. As a result of this geometry, the footprint of the container 100 is established throughout the majority of the sidewall portion 160, except for minor deviations such as at one or more volume control depressions 166, which can be formed within the sidewall portion 160. The volume control depressions 166 are formed during the blow molding process as a result of placing of volume control inserts within the mold that is used to form the container 100 in order to reduce the interior volume of the container 100 to a desired volume. In some implementations, the volume control depressions 166 are omitted.

The sidewall portion 160 includes a plurality of sidewalls. Four long sidewalls are arranged in and define a substantially rectangular configuration, with the corners of the rectangular configuration being truncated by four short sidewalls. All of the sidewalls can be substantially planar, with curved transitions 161 smoothing the intersections between adjacent sidewalls.

The arrangement of the sidewalls will be explained with reference to a longitudinal axis 104 and a transverse axis 106. The longitudinal axis 104 and the transverse axis 106 are both defined within a plane that is perpendicular to the spout axis 102. Within this plane, the longitudinal axis 104 and the transverse axis 106 are oriented such that they are perpendicular to one another. Furthermore, the intersection of the longitudinal axis 104 with the transverse axis 106 is aligned on the spout axis 102. As will be explained further herein, the footprint of the container 100, as defined by the geometry of the plurality of sidewalls, is non-symmetrical with respect to both the longitudinal axis 104 and the transverse axis 106.

The plurality of sidewalls of the sidewall portion 160 includes a first longitudinal sidewall 172 and a second longitudinal sidewall 174. The first longitudinal sidewall 172 and the second longitudinal sidewall 174 can each be substantially planar. The first longitudinal sidewall 172 is positioned directly below the handle 140 of the container, and extends from the lower limit 162 of the sidewall portion 160 to the handle 140 and the handle area 142. The second longitudinal sidewall 174 extends from the lower limit 162 of the sidewall portion 160 to the upper limit 164 of the sidewall portion 160.

The first longitudinal sidewall 172 and the second longitudinal sidewall 174 oppose each other and therefore define opposite sides of the container 100 along the longitudinal axis 104. Since the second longitudinal sidewall 174 is therefore positioned opposite the handle 140, the second longitudinal sidewall 174 is oriented on the side of the container 100 that faces the direction in which material (e.g. liquid dairy product) is poured from the container 100 during use in the conventional and expected manner by a user grasping the handle 140 and rotating the container in a direction that is generally away from the user's hand.

The first longitudinal sidewall 172 and the second longitudinal sidewall 174 are spaced apart along the longitudinal axis 104 by a longitudinal dimension of the container 100. In the illustrated implementation, in a one gallon size container of ten inch height, the longitudinal dimension of the container is approximately 7.084 inches. The spout axis 102 can be positioned such that each of the first longitudinal sidewall 172 and the second longitudinal sidewall 174 are spaced from the spout axis 102 by half the longitudinal dimension, as measured along the longitudinal axis 104. Thus, the spout axis 102 is equidistant from the first longitudinal sidewall 172 and the second longitudinal sidewall 174.

The first longitudinal sidewall 172 and the second longitudinal sidewall 174 each extend substantially perpendicular to the longitudinal axis 104. As a result, the first longitudinal sidewall 172 and the second longitudinal sidewall 174 are substantially parallel with respect to one another. Furthermore, a widthwise midpoint 173 of the first longitudinal sidewall 172 and a widthwise midpoint 175 of the second longitudinal sidewall 174 are each aligned with the longitudinal axis 104.

The first longitudinal sidewall 172 and the second longitudinal sidewall 174 each have a width that is smaller than the width of the other sidewalls from the plurality of sidewalls of the container 100. The width of the first longitudinal sidewall 172 can be the same as the width of the second longitudinal sidewall 174.

The first longitudinal sidewall 172 and the second longitudinal sidewall 174 can be opposed and/or parallel. Thus, the first longitudinal sidewall 172 and the second longitudinal sidewall 174 may be referred to herein as a first pair of sidewalls, a first pair of opposed sidewalls, a first pair of parallel sidewalls, or a first pair of opposed parallel sidewalls.

The plurality of sidewalls of the sidewall portion 160 further includes a first transverse sidewall 178 and a second transverse sidewall 180. The first transverse sidewall 178 and the second transverse sidewall 180 can each be substantially planar. The first transverse sidewall 178 and the second transverse sidewall 180 each extend from the lower limit 162 of the sidewall portion 160 to the upper limit 164 of the sidewall portion 160.

The first transverse sidewall 178 and the second transverse sidewall 180 oppose each other and therefore define opposite sides of the container 100 along the transverse axis 106. The first transverse sidewall 178 and the second transverse sidewall 180 are spaced apart along the transverse axis 106 by a transverse dimension of the container 100. The transverse dimension of the container 100 can be less than the longitudinal dimension of the container. As an example, the transverse dimension of the container 100 can be approximately 92.9 percent of the longitudinal dimension of the container 100. In the illustrated implementation, in a one gallon size container of ten inch height, the transverse dimension of the container 100 is approximately 6.580 inches.

The spout axis 102 can be positioned such that each of the first transverse sidewall 178 and the second transverse sidewall 180 are spaced from the spout axis 102 by half the transverse dimension, as measured along the transverse axis 106. Thus, the spout axis 102 is equidistant from the first transverse sidewall 178 and the second transverse sidewall 180.

The first transverse sidewall 178 and the second transverse sidewall 180 each extend substantially perpendicular to the transverse axis 106. As a result, the first transverse sidewall 178 and the second transverse sidewall 180 are substantially parallel with respect to one another. In addition, the first transverse sidewall 178 and the second transverse sidewall 180 extend substantially perpendicular to the first longitudinal sidewall 172 and the second longitudinal sidewall 174.

The first transverse sidewall 178 and the second transverse sidewall 180 each have a width that is greater than the width of the first longitudinal sidewall 172 and the second longitudinal sidewall 174, but less than the width of the remaining sidewalls of the sidewall portion 160 of the container 100. The width of the first transverse sidewall 178 can be the same as the width of the second transverse sidewall 180.

The first transverse sidewall 178 and the second transverse sidewall 180 are offset from one another in the longitudinal direction of the container 100, which is also the widthwise direction of the first transverse sidewall 178 and the second transverse sidewall 180. In particular, the first transverse sidewall 178 has a widthwise midpoint 179, and the second transverse sidewall 180 has a widthwise midpoint 181. The widthwise midpoint 179 and the widthwise midpoint 181 are offset from one another in a direction parallel to the transverse axis 106. Thus, the widthwise midpoint 179 of the first transverse sidewall 178 is not aligned with the widthwise midpoint 181 of the second transverse sidewall 180 in the transverse direction (i.e. a direction parallel to the transverse axis 106) of the container 100.

Although the first transverse sidewall 178 and the second transverse sidewall 180 are offset from one another, they still oppose one another. In particular, at least part of the first transverse sidewall 178 is directly opposite at least part of the second transverse sidewall 180. Thus, a line can be constructed perpendicular to the longitudinal axis 104 that extends through both the first transverse sidewall 178 to the second transverse sidewall 180, and optionally such that the line passes directly under the opening 151. An example of such a line is the transverse axis 106.

In the illustrated example the widthwise midpoint 179 of the first transverse sidewall 178 is positioned rearward of the transverse axis 106 and the widthwise midpoint 181 of the second transverse sidewall 180 is positioned forward of the transverse axis 106. Herein, forward and rearward are defined along any line parallel to the longitudinal axis 104 (i.e. the longitudinal direction of the container), with forward being toward the second longitudinal sidewall 174 and rearward being toward the first longitudinal sidewall 172, with the second longitudinal sidewall 174 defined as being at the front of the container 100 and the first longitudinal sidewall 172 defined as being at the back of the container 100.

The first transverse sidewall 178 and the second transverse sidewall 180 can be opposed and/or parallel. Thus, the first transverse sidewall 178 and the second transverse sidewall 180 may be referred to herein as a second pair of sidewalls, a second pair of opposed sidewalls, a second pair of parallel sidewalls, or a second pair of opposed parallel sidewalls.

Collectively, the first longitudinal sidewall 172, the second longitudinal sidewall 174, the first transverse sidewall 178 and the second transverse sidewall 180 may be referred to herein as a group of short sidewalls, given that the remaining sidewalls of the container 100 all have a larger width than any of them.

The remaining sidewalls of sidewall portion of the container 100 may be referred to herein as a group of long sidewalls, and include a first long sidewall 182, a second long sidewall 184, a third long sidewall 186 and a fourth long sidewall 188. All of the long sidewalls can be substantially planar. Each of the long sidewalls is positioned between a pair of the short sidewalls. The long sidewalls define a rectangular shape, with the corners of the rectangular shape being truncated by the short sidewalls.

The first long sidewall 182 and the second long sidewall 184 are positioned adjacent to the handle area 142 on opposite sides of the first longitudinal sidewall 172. Thus, the first long sidewall 182 and the second long sidewall 184 are disposed on opposite sides of the longitudinal axis 104, with each extending at approximately a 45 degree angle with respect to the longitudinal axis 104. The first long sidewall 182 extends from the first longitudinal sidewall 172 to the first transverse sidewall 178. The second long sidewall 184 extends from the first longitudinal sidewall 172 to the second transverse sidewall 180. The second long sidewall 184 is wider than the first long sidewall 182.

The third long sidewall 186 and the fourth long sidewall 188 are positioned on opposite sides of the second longitudinal sidewall 174 and thus are positioned on opposite sides of the longitudinal axis 104, with each extending at approximately a 45 degree angle with respect to the longitudinal axis 104. The third long sidewall 186 extends from the first transverse sidewall 178 to the second longitudinal sidewall 174. The fourth long sidewall 188 extends from the second longitudinal sidewall 174 to the second transverse sidewall 180. The third long sidewall 186 is wider than the fourth long sidewall 188.

The first long sidewall 182 is positioned opposite the fourth long sidewall 188. In addition to opposing one another, the first long sidewall 182 and the fourth long sidewall 188 extend substantially parallel to one another. Thus, the first long sidewall 182 and the fourth long sidewall 188 can be opposed and/or parallel. Thus, the first long sidewall 182 and the fourth long sidewall 188 may be referred to herein as a third pair of sidewalls, a third pair of opposed sidewalls, a third pair of parallel sidewalls, or a third pair of opposed parallel sidewalls.

The first long sidewall 182 and the fourth long sidewall 188 can be of the same width, and are spaced apart from one another by a first width dimension of the container 100.

The second long sidewall 184 is positioned opposite the third long sidewall 186. In addition to opposing one another, the second long sidewall 184 and the third long sidewall 186 extend substantially parallel to one another. The second long sidewall 184 and the third long sidewall 186 can be opposed and/or parallel. Thus, the second long sidewall 184 and the third long sidewall 186 may be referred to herein as a fourth pair of sidewalls, a fourth pair of opposed sidewalls, a fourth pair of parallel sidewalls, or a fourth pair of opposed parallel sidewalls.

The second long sidewall 184 and the third long sidewall 186 can be of the same width, and are spaced apart from one another by a second width dimension of the container 100.

To define the truncated rectangular configuration of the footprint of the container 100, the first width dimension is greater than the second width dimension. Thus, the first long sidewall 182 and the fourth long sidewall 188 are spaced apart by a distance that is greater than the distance by which the second long sidewall 184 is spaced apart from the third long sidewall 186. In particular, the first width dimension of the container 100 can be greater than the second width dimension of the container.

In the illustrated implementation, for example, the first width dimension is approximately 5.825 inches and the second width dimension is approximately 5.6 inches. As a result the second width dimension is approximately 96.1 percent of the first width dimension.

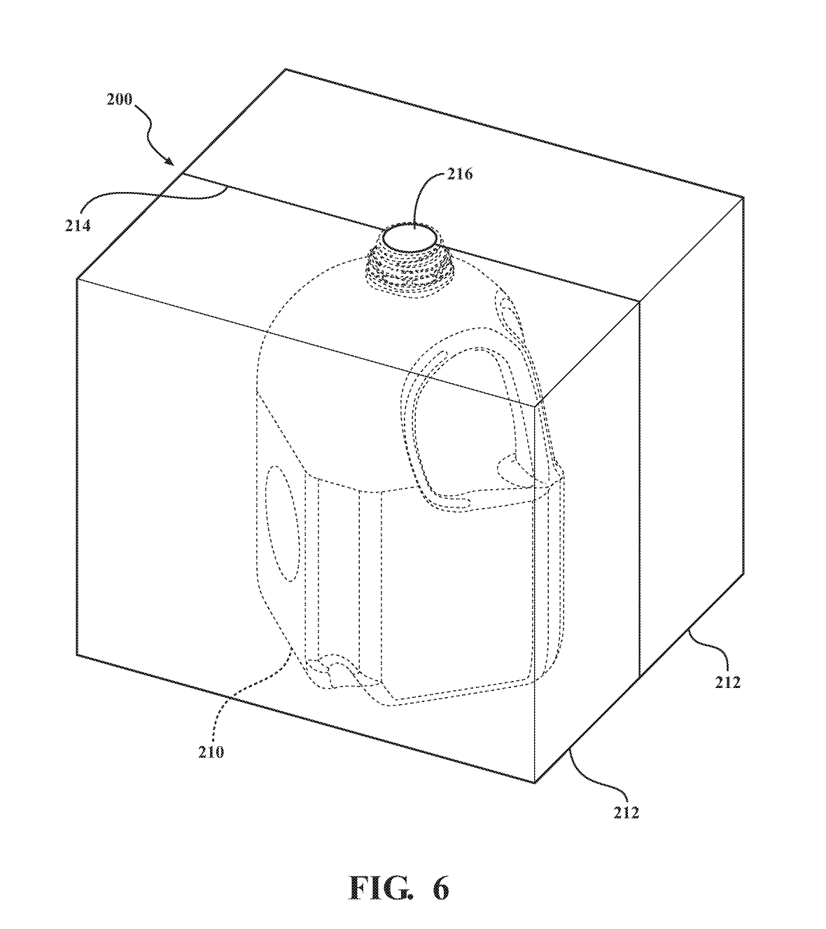

The container 100 can be formed, for example, using a mold 200, as shown in FIG. 6. The mold 200 defines a mold cavity 210, with sections of the mold cavity 210 having geometric features that correspond to the various, parts, portions, and features of the container 100 as described above. The mold 200 has two or more mold parts 212 that meet at one or more split lines 214 to allow the mold to be opened or closed. An opening 216 is formed at the top of the mold to receive thermoplastic material, with the opening corresponding to the area of the mold cavity 210 that corresponds to the spout 150 of the container 100.

The container 100 can be formed, for example, using the tooling and process described in U.S. Pat. No. 8,535,599 in conjunction with the mold 200. The tooling and process include a blow molding machine in which an extrusion mechanism positions a circular mandrel having an air passage in a circular die so that a predetermined die gap exists between the mandrel and the die at a predetermined die angle. The die gap for a one gallon container can be for example, between about 0.001″ and about 0.025″ or more particularly about 0.006″. The die angle can range from 0° to 30° or more particularly about 15 degrees to 18 degrees.

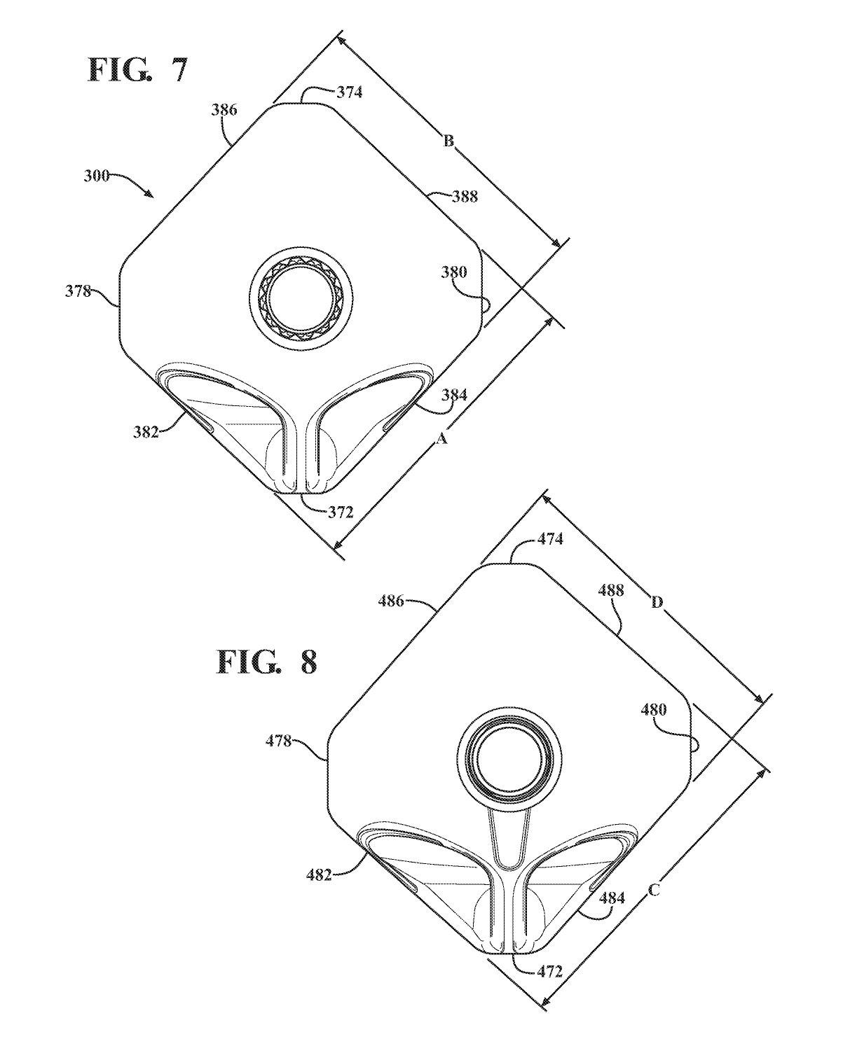

FIG. 7 shows a container 300, which is similar to the container 100 except as stated. The container 300 is configured to hold one gallon of liquid, such as dairy products, and thus may have an interior volume slightly greater than one gallon. The container 300 has a first longitudinal sidewall 372, a second longitudinal sidewall 374, a first transverse sidewall 378, a second transverse sidewall 380, a first long sidewall 382, a second long sidewall 384, a third long sidewall 386, and a fourth long sidewall 388.

The container 300 may have an overall height of ten inches, or an overall height of approximately ten inches, such as an overall height between 9.8 inches and 10.2 inches. Similar to the container 100, the longitudinal dimension of the container 300 is approximately 7.084 inches and the transverse dimension of the container 300 is approximately 6.580 inches.

The first long sidewall 382 and the fourth long sidewall 388 can be of the same width, and are spaced apart from one another by a first width dimension A of the container 300. The second long sidewall 384 and the third long sidewall 386 can be of the same width, and are spaced apart from one another by a second width dimension B of the container 300.

In the illustrated implementation, for example, the first width dimension A is approximately 5.825 inches and the second width dimension B is approximately 5.6 inches. As a result the second width dimension is approximately 96.1 percent of the first width dimension.

FIG. 8 shows a container 400, which is similar to the container 100 except as stated. The container 400 is configured to hold one gallon of liquid, such as dairy products, and thus may have an interior volume slightly greater than one gallon. The container 400 has a first longitudinal sidewall 472, a second longitudinal sidewall 474, a first transverse sidewall 478, a second transverse sidewall 480, a first long sidewall 482, a second long sidewall 484, a third long sidewall 486, and a fourth long sidewall 488.

The container 400 may have an overall height of ten inches, or an overall height of approximately ten inches, such as an overall height between 9.8 inches and 10.2 inches. Similar to the container 100, the longitudinal dimension of the container 400 is approximately 7.084 inches and the transverse dimension of the container 400 is approximately 6.580 inches.

The first long sidewall 482 and the fourth long sidewall 488 can be of the same width, and are spaced apart from one another by a first width dimension C of the container 400. The second long sidewall 484 and the third long sidewall 486 can be of the same width, and are spaced apart from one another by a second width dimension D of the container 400.

In the illustrated implementation, for example, the first width dimension C is approximately 5.940 inches and the second width dimension D is approximately 5.5 inches. As a result the second width dimension is approximately 92.6 percent of the first width dimension.

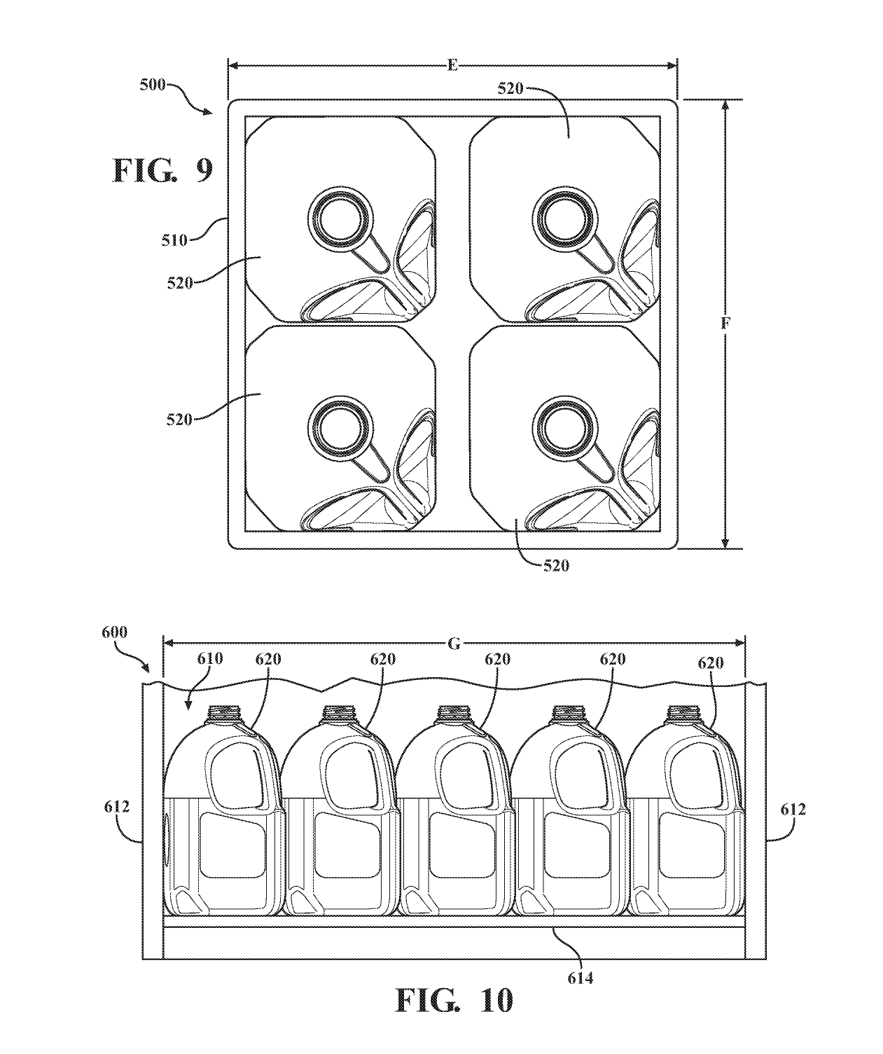

The container 300 and the container 400 are examples of containers in which the first width dimensions A, C and the second width dimensions B, D are configured to allow the containers to fit within a 6 inch by 6 inch square area, while minimizing the second width dimensions B, D, maintaining adequate strength, and minimizing the weight of the container. This allows four containers to fit in a typical U.S. size dairy crate, such as the crate 500 as shown in FIG. 9. The crate 500 has a peripheral wall 510 that defines a square (as viewed from above) interior space with a first interior dimension E and a second interior dimension F, where the first interior dimension E and a second interior dimension F are both equal to twelve inches. Four containers 520 are able to fit within the crate 500. The containers 520 may be identical to the containers 100, 300, 400, as previously described.

By minimizing the second width dimensions B, D of the containers 300, 400, they may be displayed more efficiently and economically in a retail setting. As shown in FIG. 10, a retail display cooler 600 has an interior space 610 in which containers 620 are stored and displayed to consumers. The containers 620 may be identical to the containers 100, 300, 400, as previously described.

The containers 620 are supported by a shelf 614 that extends between upright walls. In the illustrated example, an interior width dimension G for the retail display cooler 600 is defined between the upright walls 612. In one implementation, the interior width dimension G is twenty eight inches. Five of the containers 620 (configured as described with respect to the containers 300, 400) may be placed in the retail display cooler with their respective first long sidewalls facing out of the retail display cooler 600 toward consumers. With typical container designs, a thirty inch wide space would be required to display five containers.

The above described examples of the first width dimensions A, C and the second width dimensions B, D are within a range of values that provide the above-described advantages. Similar result can be achieved in containers configured as above and in which the first width dimension is a maximum of (i.e. equal to or less than) six inches the second width dimension is between 90.0 percent (e.g. the first width dimension is 6.0 inches and the second width dimension is 5.4 inches) and 96.14 percent of the first width dimension.

While the disclosure has been made in connection with what is presently considered to be the most practical and preferred implementation, it should be understood that the disclosure is intended to cover various modifications and equivalent arrangements.

1. A blow-molded dairy container, comprising:
a spout that is arranged on a spout axis;
a bottom portion;
a handle;
an upwardly converging top portion,
short sidewalls that includes a first longitudinal sidewall that is located adjacent to the handle, a second longitudinal sidewall that is located opposite the first longitudinal sidewall, a first transverse sidewall, and a second transverse sidewall that is located opposite the first transverse sidewall and is offset from the first transverse sidewall in a longitudinal direction; and
long sidewalls that are each positioned between a respective pair of the short sidewalls, wherein a first pair of the long sidewalls are spaced by a first width dimension, a second pair of the long sidewalls are spaced by a second width dimension, the first width dimension is a maximum of six inches, and the second width dimension is between 90.0 and 96.14 percent of the first width dimension.

2. The blow-molded dairy container of claim 1, wherein the first transverse sidewall is spaced from the second transverse sidewall along a transverse axis that intersects the spout axis, extends perpendicular to the first transverse sidewall, extends perpendicular to the second transverse sidewall, passes through the first transverse sidewall, and passes through the second transverse sidewall.

3. The blow-molded dairy container of claim 2, wherein the first longitudinal sidewall is spaced from the second longitudinal sidewall along a longitudinal axis that intersects the spout axis, extends perpendicular to the first longitudinal sidewall, and extends perpendicular to the second longitudinal sidewall.

4. The blow-molded dairy container of claim 3, wherein the first transverse sidewall has a first widthwise midpoint and the second transverse sidewall has a second widthwise midpoint.

5. The blow-molded dairy container of claim 4, wherein the first widthwise midpoint and the second widthwise midpoint are not aligned.

6. The blow-molded dairy container of claim 4, and the first widthwise midpoint is not aligned with the second widthwise midpoint in a transverse direction, wherein the transverse direction is parallel to the transverse axis.

7. The blow-molded dairy container of claim 4, wherein the first widthwise midpoint is located rearward of the transverse axis and the second widthwise midpoint is located forward of the transverse axis.

8. The blow-molded dairy container of claim 7, wherein the long sidewalls include a first long sidewall, a second long sidewall, a third long sidewall, and a fourth long sidewall, the first long sidewall is opposite and parallel to the fourth long sidewall, and the second long sidewall is opposite and parallel to the third long sidewall.

9. The blow-molded dairy container of claim 8, wherein the first longitudinal sidewall is spaced from the second longitudinal sidewall by a first distance, first transverse sidewall is spaced from the second transverse sidewall by a second distance, the first long sidewall is spaced from the fourth long sidewall by a third distance, and the second long sidewall is spaced from the third long sidewall by a fourth distance.

10. The blow-molded dairy container of claim 9, wherein the first distance is greater than the second distance, the second distance is greater than the third distance, and the third distance is greater than the fourth distance.

11. A mold for making a blow-molded dairy container, comprising:
two or more mold portions that define a mold cavity having:
a spout section for forming a spout that is arranged on a spout axis,
a bottom section for forming a bottom portion,
a handle section for forming a handle,
a top section for forming an upwardly converging top portion, and
a sidewall section for forming short sidewalls and long sidewalls, the short sidewalls including a first longitudinal sidewall that is located adjacent to the handle, a second longitudinal sidewall that is located opposite the first longitudinal sidewall, a first transverse sidewall, and a second transverse sidewall that is located opposite the first transverse sidewall and is offset from the first transverse sidewall in a longitudinal direction, the long sidewalls each being positioned between a respective pair of the short sidewalls, wherein a first pair of the long sidewalls are spaced by a first width dimension, a second pair of the long sidewalls are spaced by a second width dimension, the first width dimension is a maximum of six inches, and the second width dimension is between 90.0 and 96.14 percent of the first width dimension.

12. The mold of claim 11, wherein the first transverse sidewall is spaced from the second transverse sidewall along a transverse axis that intersects the spout axis, extends perpendicular to the first transverse sidewall, and extends perpendicular to the second transverse sidewall, passes through the first transverse sidewall, and passes through the second transverse sidewall.

13. The mold of claim 12, wherein the first longitudinal sidewall is spaced from the second longitudinal sidewall along a longitudinal axis that intersects the spout axis, extends perpendicular to the first longitudinal sidewall, and extends perpendicular to the second longitudinal sidewall.

14. The mold of claim 13, wherein the first transverse sidewall has a first widthwise midpoint and the second transverse sidewall has a second widthwise midpoint.

15. The mold of claim 14, wherein the first widthwise midpoint and the second widthwise midpoint are not aligned.

16. The mold of claim 14, and the first widthwise midpoint is not aligned with the second widthwise midpoint in a transverse direction, wherein the transverse direction is parallel to the transverse axis.

17. The mold of claim 14, wherein the first widthwise midpoint is located rearward of the transverse axis and the second widthwise midpoint is located forward of the transverse axis.

18. The mold of claim 17, wherein long sidewalls include a first long sidewall, a second long sidewall, a third long sidewall, and a fourth long sidewall, the first long sidewall is opposite and parallel to the fourth long sidewall, and the second long sidewall is opposite and parallel to the third long sidewall.

19. The mold of claim 18, wherein the first longitudinal sidewall is spaced from the second longitudinal sidewall by a first distance, first transverse sidewall is spaced from the second transverse sidewall by a second distance, the first long sidewall is spaced from the fourth long sidewall by a third distance, and the second long sidewall is spaced from the third long sidewall by a fourth distance.

20. The mold of claim 19, wherein the first distance is greater than the second distance, the second distance is greater than the third distance, and the third distance is greater than the fourth distance.
